(19) United States
(12) Patent Application Publication
(10) Pub. No.: US 2021/0177040 A1
(43) Pub. Date: Jun. 17, 2021

(54) AEROSOLIZABLE FORMULATION

(71) Applicant: NICOVENTURES TRADING LIMITED, London (GB)

(72) Inventors: Colin DICKENS, London (GB); Ross CABOT, London (GB); James NICOL, London (GB)

(73) Assignee: NICOVENTURES TRADING LIMITED, London (GB)

(21) Appl. No.: 16/761,060

(22) PCT Filed: Oct. 31, 2018
(86) PCT No.: PCT/GB2018/053138

§ 371 Date: May 1, 2020

(30) Foreign Application Priority Data
Nov. 1, 2017 (GB) 1718035.7

(51) Int. Cl. A24B 15/167; A24F 40/05; A24F 40/10

(52) U.S. Cl. CPC A24B 15/167; A24F 40/10; A24F 40/05

(57) ABSTRACT

There is provided an aerosolizable formulation comprising (i) water in an amount of at least 50 wt. % based on the aerosolizable formulation; (ii) one or more flavors; and (iii) one or more cyclodextrins.

### CROSS-REFERENCE TO RELATED APPLICATIONS

The present application is a National Phase entry of PCT Application No. PCT/GB2018/053138, filed Oct. 31, 2018, which claims priority from Great Britain Patent Application No. 1718035.7 filed Nov. 1, 2017, each of which is fully incorporated herein by reference.

### FIELD OF THE INVENTION

The present disclosure relates to an aerosolizable formulation, containers in which are contained the aerosolizable formulation and to electronic aerosol provision systems such as electronic aerosol delivery systems (e.g. e-cigarettes) incorporating said formulation.

### BACKGROUND TO THE INVENTION

Electronic vapor provision systems such as e-cigarettes generally contain a reservoir of liquid which is to be vaporized, typically containing nicotine. When a user inhales on the device, a heater is activated to vaporize a small amount of liquid, which is therefore inhaled by the user.

The use of e-cigarettes in the UK has grown rapidly, and it has been estimated that there are now almost three million people using them in the UK.

Current e-cigarette formulations utilize components such as glycerol and/or propylene glycol as the excipient substances.

Furthermore, e-cigarette formulations may comprise hydrophobic flavor components such as menthol which necessitate use of solvents such as ethanol to achieve full miscibility with the excipient components and water. Flavors like these tend to be volatile, and vaporize readily in the presence of heat. The inherent problem with this is that current e-cigarette devices will heat to an excess, leading to degradation of flavor quality and consumer satisfaction.

### SUMMARY OF THE INVENTION

In one aspect there is provided an aerosolizable formulation comprising

(i) water in an amount of at least 50 wt. % based on the aerosolizable formulation;

(ii) one or more flavors; and

(iii) one or more cyclodextrins.

The present invention further provides a process for forming an aerosol, the process comprising aerosolizing an aerosolizable formulation comprising

(i) water in an amount of at least 50 wt. % based on the aerosolizable formulation;

(ii) one or more flavors; and

(iii) one or more cyclodextrins.

Aspects of the present invention further provides a contained aerosolizable formulation comprising

(a) a container; and

(b) an aerosolizable formulation, comprising

(i) water in an amount of at least 50 wt. % based on the aerosolizable formulation;

(ii) one or more flavors; and

(iii) one or more cyclodextrins.

An aspect of the present invention further provides an electronic aerosol provision system comprising:

(a) an aerosolizer for aerosolizing formulation for inhalation by a user of the electronic aerosol provision system;

(b) a power supply comprising a cell or battery for supplying power to the aerosolizer

(c) an aerosolizable formulation, comprising

(i) water in an amount of at least 50 wt. % based on the aerosolizable formulation;

(ii) one or more flavors; and

(iii) one or more cyclodextrins.

An aspect of the present invention further provides a process for at least one of increasing solubility of a flavor and/or reducing loss of flavor over time of a flavored aerosolizable formulation

the process comprising the steps of

(a) providing an aerosolizable material comprising water in an amount of at least 50 wt. % based on the aerosolizable material;

(b) incorporating into the aerosolizable material one or more flavors and one or more cyclodextrins.

An aspect of the present invention further provides a process for preparing an aerosolizable formulation comprising

(i) water in an amount of at least 50 wt. % based on the aerosolizable formulation;

(ii) one or more flavors;

(iii) one or more cyclodextrins; and

(iv) one or more active agents,

the process comprising the steps of

(a) contacting water, the one or more cyclodextrins and at least one of the one or more active agents to form an initial cyclodextrin composition;

(b) subsequently contacting the initial cyclodextrin composition with the one or more flavors.

An aspect of the present invention further provides use of one or more cyclodextrins for delivering a flavor in an aerosol, wherein the aerosol is formed by aerosolizing an aerosolizable formulation comprising

(i) water in an amount of at least 50 wt. % based on the aerosolizable formulation;

(ii) one or more flavors; and

(iii) one or more cyclodextrins.

at a temperature below 50° C.

### DETAILED DESCRIPTION

As discussed herein the present invention provides an aerosolizable formulation comprising

(i) water in an amount of at least 50 wt. % based on the aerosolizable formulation;

(ii) one or more flavors; and

(iii) one or more cyclodextrins.

The use of cyclodextrins to solubilize hydrophobic drugs has been documented in the pharmaceutical industry. Specifically, cyclodextrins have been used where drugs are designed for treatment of respiratory diseases and therefore intended for deep lung inhalation. Furthermore, the use of cyclodextrins to encapsulate flavors is known in consumer products, albeit not for products designed for inhalation. Therefore, there is an understanding in the art that cyclodextrins may be used for encapsulating active products and for encapsulating flavors, such as menthol, and in particular for ensuring the stability of formulated actives and flavors. However, this encapsulation is generally considered to be strong and one would not expect the flavor to be readily released on use of the product. We have found that by incorporating the flavor in a formulation containing a large amount of water, namely at least 50 wt. %, an aerosolizable formulation may be provided wherein, when an aerosol is generated, the flavor is released from encapsulation by the cyclodextrins.

These high water systems are unusual in the field of aerosol delivery devices, such as electronic cigarettes. The formulations delivered by such devices typically use greater amounts of excipients such as glycerol and/or propylene glycol. We have surprisingly found that by providing a formulation containing greater than 50 wt % water, and one or more cyclodextrins, such as 2-hydroxypropyl-O-cyclodextrin (HPbCD), an inclusion complex is provided containing both the flavor compound and, if present, active substance. This formulation can be delivered using non-heating means, such as the provision of ultrasonic energy through a vibrating mesh. Typically such high water content formulations are not suitable for aerosol delivery devices because the heat required to vaporize such significant quantities of water is too great. The avoidance of heat avoids the problems of heat degradation discussed above, and it has surprisingly been found that the flavor is still capable of being release from the cyclodextrin even though the formulation is not heated to produce a condensation aerosol.

For ease of reference, these and further aspects of the present invention are now discussed under appropriate section headings. However, the teachings under each section are not necessarily limited to each particular section.

Water

As discussed here the aerosolizable formulation of the present invention comprises water in an amount of at least 50 wt. % based on the aerosolizable formulation.

In one aspect water is present in an amount of at least 55 wt. % based on the aerosolizable formulation. In one aspect water is present in an amount of at least 60 wt. % based on the aerosolizable formulation. In one aspect water is present in an amount of at least 65 wt. % based on the aerosolizable formulation. In one aspect water is present in an amount of at least 70 wt. % based on the aerosolizable formulation. In one aspect water is present in an amount of at least 75 wt. % based on the aerosolizable formulation. In one aspect water is present in an amount of at least 80 wt. % based on the aerosolizable formulation. In one aspect water is present in an amount of at least 85 wt. % based on the aerosolizable formulation. In one aspect water is present in an amount of at least 90 wt. % based on the aerosolizable formulation.

In one aspect water is present in an amount of from 55 to 99 wt. % based on the aerosolizable formulation. In one aspect water is present in an amount of from 60 to 99 wt. % based on the aerosolizable formulation. In one aspect water is present in an amount of from 65 to 99 wt. % based on the aerosolizable formulation. In one aspect water is present in an amount of from 70 to 99 wt. % based on the aerosolizable formulation. In one aspect water is present in an amount of from 75 to 99 wt. % based on the aerosolizable formulation. In one aspect water is present in an amount of from 80 to 99 wt. % based on the aerosolizable formulation. In one aspect water is present in an amount of from 85 to 99 wt. % based on the aerosolizable formulation. In one aspect water is present in an amount of from 90 to 99 wt. % based on the aerosolizable formulation.

In one aspect water is present in an amount of from 55 to 95 wt. % based on the aerosolizable formulation. In one aspect water is present in an amount of from 60 to 95 wt. % based on the aerosolizable formulation. In one aspect water is present in an amount of from 65 to 95 wt. % based on the aerosolizable formulation. In one aspect water is present in an amount of from 70 to 95 wt. % based on the aerosolizable formulation. In one aspect water is present in an amount of from 75 to 95 wt. % based on the aerosolizable formulation. In one aspect water is present in an amount of from 80 to 95 wt. % based on the aerosolizable formulation. In one aspect water is present in an amount of from 85 to 95 wt. % based on the aerosolizable formulation. In one aspect water is present in an amount of from 90 to 95 wt. % based on the aerosolizable formulation.

In one aspect water is present in an amount of from 55 to 90 wt. % based on the aerosolizable formulation. In one aspect water is present in an amount of from 60 to 90 wt. % based on the aerosolizable formulation. In one aspect water is present in an amount of from 65 to 90 wt. % based on the aerosolizable formulation. In one aspect water is present in an amount of from 70 to 90 wt. % based on the aerosolizable formulation. In one aspect water is present in an amount of from 75 to 90 wt. % based on the aerosolizable formulation. In one aspect water is present in an amount of from 80 to 90 wt. % based on the aerosolizable formulation. In one aspect water is present in an amount of from 85 to 90 wt. % based on the aerosolizable formulation.

Flavors

As used herein, the terms “flavor” and “flavorant” refer to materials which, where local regulations permit, are added with the formulation to create a desired taste or aroma in a product for adult consumers. Thus, whilst it is acknowledged that some other functional components of the formulation may contain components that have a perceptible flavor or aroma, such components are not added for this purpose and as such are not considered to be a “flavor” or “flavorant” in the context of the present invention. Furthermore, it will be understood that “flavors” or “flavorants” may well composed of one or more individual compounds that together form an identifiable flavor. As such, reference here to “flavor” or “flavorant” includes both singular and multi-component flavors.

As discussed here the aerosolizable formulation of the present invention comprises one or more flavors.

In one aspect the aerosolizable formulation of the present invention comprises only one flavor. In one aspect the aerosolizable formulation of the present invention comprises more than one flavor. In one aspect the aerosolizable formulation of the present invention comprises two or more flavors. In one aspect the aerosolizable formulation of the present invention comprises only two flavors. In one aspect the aerosolizable formulation of the present invention comprises three or more flavors. In one aspect the aerosolizable formulation of the present invention comprises only three flavors. In one aspect the aerosolizable formulation of the present invention comprises four or more flavors. In one aspect the aerosolizable formulation of the present invention comprises only four flavors. In one aspect the aerosolizable formulation of the present invention comprises five or more flavors. In one aspect the aerosolizable formulation of the present invention comprises only five flavors.

In one aspect the one or more flavors are selected from the group consisting of extracts (e.g. licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In one aspect the one or more flavors are selected from the group consisting of (4-(para-)methoxyphenyl)-2-butanone, vanillin, γ-undecalactone, menthone, 5-propenyl guaethol, menthol, para-mentha-8-thiol-3-one and mixtures thereof.

In one aspect the flavor is at least menthol. In one aspect the flavor is only menthol. In one aspect menthol comprises at least 30 wt. % of the flavors present in the aerosolizable formulation. In one aspect menthol comprises at least 40 wt. % of the flavors present in the aerosolizable formulation. In one aspect menthol comprises at least 50 wt. % of the flavors present in the aerosolizable formulation. In one aspect menthol comprises at least 60 wt. % of the flavors present in the aerosolizable formulation. In one aspect menthol comprises at least 70 wt. % of the flavors present in the aerosolizable formulation.

In one aspect, at least one of the one or more flavors is hydrophobic. In one aspect each of the one or more flavors is hydrophobic. In a further aspect, the present invention provides an aerosolizable formulation comprising

(i) water in an amount of at least 50 wt. % based on the aerosolizable formulation;

(ii) one or more hydrophobic flavors; and

(iii) one or more cyclodextrins.

The one or more flavors may be present in any amount to deliver the desired flavor to the aerosolizable formulation. In one aspect the one or more flavors are present in a total amount of no greater than 10 wt. % based on the aerosolizable formulation. In one aspect the one or more flavors are present in a total amount of no greater than 9 wt. % based on the aerosolizable formulation. In one aspect the one or more flavors are present in a total amount of no greater than 8 wt. % based on the aerosolizable formulation. In one aspect the one or more flavors are present in a total amount of no greater than 7 wt. % based on the aerosolizable formulation. In one aspect the one or more flavors are present in a total amount of no greater than 6 wt. % based on the aerosolizable formulation. In one aspect the one or more flavors are present in a total amount of no greater than 5 wt. % based on the aerosolizable formulation. In one aspect the one or more flavors are present in a total amount of no greater than 4 wt. % based on the aerosolizable formulation. In one aspect the one or more flavors are present in a total amount of no greater than 3 wt. % based on the aerosolizable formulation. In one aspect the one or more flavors are present in a total amount of no greater than 2 wt. % based on the aerosolizable formulation. In one aspect the one or more flavors are present in a total amount of no greater than 1.8 wt. % based on the aerosolizable formulation. In one aspect the one or more flavors are present in a total amount of no greater than 1.6 wt. % based on the aerosolizable formulation. In one aspect the one or more flavors are present in a total amount of no greater than 1.5 wt. % based on the aerosolizable formulation. In one aspect the one or more flavors are present in a total amount of no greater than 1.4 wt. % based on the aerosolizable formulation. In one aspect the one or more flavors are present in a total amount of no greater than 1.3 wt. % based on the aerosolizable formulation. In one aspect the one or more flavors are present in a total amount of no greater than 1.2 wt. % based on the aerosolizable formulation. In one aspect the one or more flavors are present in a total amount of no greater than 1.1. wt. % based on the aerosolizable formulation. In one aspect the one or more flavors are present in a total amount of no greater than 1 wt. % based on the aerosolizable formulation.

In one aspect the one or more flavors are present in a total amount of at least 0.01 wt. % based on the aerosolizable formulation. In one aspect the one or more flavors are present in a total amount of at least 0.02 wt. % based on the aerosolizable formulation. In one aspect the one or more flavors are present in a total amount of at least 0.03 wt. % based on the aerosolizable formulation. In one aspect the one or more flavors are present in a total amount of at least 0.04 wt. % based on the aerosolizable formulation. In one aspect the one or more flavors are present in a total amount of at least 0.05 wt. % based on the aerosolizable formulation. In one aspect the one or more flavors are present in a total amount of at least 0.06 wt. % based on the aerosolizable formulation. In one aspect the one or more flavors are present in a total amount of at least 0.07 wt. % based on the aerosolizable formulation. In one aspect the one or more flavors are present in a total amount of at least 0.08 wt. % based on the aerosolizable formulation. In one aspect the one or more flavors are present in a total amount of at least 0.09 wt. % based on the aerosolizable formulation. In one aspect the one or more flavors are present in a total amount of at least 0.1 wt. % based on the aerosolizable formulation. In one aspect the one or more flavors are present in a total amount of at least 0.2 wt. % based on the aerosolizable formulation. In one aspect the one or more flavors are present in a total amount of at least 0.3 wt. % based on the aerosolizable formulation. In one aspect the one or more flavors are present in a total amount of at least 0.4 wt. % based on the aerosolizable formulation. In one aspect the one or more flavors are present in a total amount of at least 0.5 wt. % based on the aerosolizable formulation. In one aspect the one or more flavors are present in a total amount of at least 0.6 wt. % based on the aerosolizable formulation. In one aspect the one or more flavors are present in a total amount of at least 0.7 wt. % based on the aerosolizable formulation. In one aspect the one or more flavors are present in a total amount of at least 0.8 wt. % based on the aerosolizable formulation. In one aspect the one or more flavors are present in a total amount of at least 0.9 wt. % based on the aerosolizable formulation.

In one aspect the one or more flavors are present in a total amount of from 0.01 to 10 wt. % based on the aerosolizable formulation. In one aspect the one or more flavors are present in a total amount of from 0.01 to 9 wt. % based on the aerosolizable formulation. In one aspect the one or more flavors are present in a total amount of from 0.01 to 8 wt. % based on the aerosolizable formulation. In one aspect the one or more flavors are present in a total amount of from 0.01 to 7 wt. % based on the aerosolizable formulation. In one aspect the one or more flavors are present in a total amount of from 0.01 to 6 wt. % based on the aerosolizable formulation. In one aspect the one or more flavors are present in a total amount of from 0.01 to 5 wt. % based on the aerosolizable formulation. In one aspect the one or more flavors are present in a total amount of from 0.01 to 4 wt. % based on the aerosolizable formulation. In one aspect the one or more flavors are present in a total amount of from 0.01 to 3 wt. % based on the aerosolizable formulation. In one aspect the one or more flavors are present in a total amount of from 0.01 to 2 wt. % based on the aerosolizable formulation. In one aspect the one or more flavors are present in a total amount of from 0.01 to 1.8 wt. % based on the aerosolizable formulation. In one aspect the one or more flavors are present in a total amount of from 0.01 to 1.6 wt. % based on the aerosolizable formulation. In one aspect the one or more flavors are present in a total amount of from 0.01 to 1.5 wt. % based on the aerosolizable formulation. In one aspect the one or more flavors are present in a total amount of from 0.01 to 1.4 wt. % based on the aerosolizable formulation. In one aspect the one or more flavors are present in a total amount of from 0.01 to 1.3 wt. % based on the aerosolizable formulation. In one aspect the one or more flavors are present in a total amount of from 0.01 to 1.2 wt. % based on the aerosolizable formulation. In one aspect the one or more flavors are present in a total amount of from 0.01 to 1.1. wt. % based on the aerosolizable formulation. In one aspect the one or more flavors are present in a total amount of from 0.01 to 1 wt. % based on the aerosolizable formulation.

We have found that the addition of the one or more flavors in a molar excess with respect to the one or more cyclodextrins may result in the one or more flavors precipitating from the formulation. Therefore in one aspect, the one or more cyclodextrins are present in a molar excess with respect to the one or more flavors. In one aspect, the molar ratio of cyclodextrins to flavors is at least 1.2:1. In one aspect, the molar ratio of cyclodextrins to flavors is at least 1.4:1. In one aspect, the molar ratio of cyclodextrins to flavors is at least 1.6:1. In one aspect, the molar ratio of cyclodextrins to flavors is at least 1.8:1. In one aspect, the molar ratio of cyclodextrins to flavors is at least 2:1. In one aspect, the molar ratio of cyclodextrins to flavors is from 5:1 to 1.5:1. In one aspect, the molar ratio of cyclodextrins to flavors is from 4:1 to 1.5:1. In one aspect, the molar ratio of cyclodextrins to flavors is from 2:1 to 1.5:1. In one aspect, the molar ratio of cyclodextrins to flavors is from 2:1 to 1.5:1. In one aspect, the molar ratio of cyclodextrins to flavors is from 2:1 to 1.2:1.

Cyclodextrins

As discussed herein, the aerosolizable formulation of the present invention comprises one or more cyclodextrins. The one or more cyclodextrins may be selected from the group consisting of unsubstituted cyclodextrins, substituted cyclodextrins and mixtures thereof. In one aspect at least one cyclodextrin is an unsubstituted cyclodextrin. In one aspect the one or more cyclodextrins are selected from the group consisting of unsubstituted cyclodextrins. In one aspect at least one cyclodextrin is a substituted cyclodextrin. In one aspect the one or more cyclodextrins are selected from the group consisting of substituted cyclodextrins.

In one aspect the one or more cyclodextrins are selected from the group consisting of unsubstituted (α)-cyclodextrin, substituted (α)-cyclodextrin, unsubstituted (β)-cyclodextrin, substituted (β)-cyclodextrin, unsubstituted (γ)-cyclodextrin, substituted (γ)-cyclodextrin, and mixtures thereof. In one aspect the one or more cyclodextrins are selected from the group consisting of unsubstituted (β)-cyclodextrin, substituted (β)-cyclodextrin, and mixtures thereof.

As discussed herein, we have found that each of the α, β and γ variants of cyclodextrin may be used and the most suitable one may be selected depending on the ‘guest’ components, such as the present flavors, to be complexed.

In one aspect the one or more cyclodextrins are selected from the group consisting of unsubstituted (α)-cyclodextrin, unsubstituted (β)-cyclodextrin, unsubstituted (γ)-cyclodextrin, and mixtures thereof. In one aspect the one or more cyclodextrins is selected from unsubstituted (β)-cyclodextrin.

In one aspect the one or more cyclodextrins are selected from the group consisting of substituted (α)-cyclodextrin, substituted (β)-cyclodextrin, substituted (γ)-cyclodextrin, and mixtures thereof. In one aspect the one or more cyclodextrins is selected from substituted (β)-cyclodextrins. Chemical substitutions at the 2-, 3-, and 6-hydroxyl sites are preferred, with substitution at the 2-position being more preferred.

In one aspect the one or more cyclodextrins are selected from the group consisting of 2-hydroxy-propyl-α-cyclodextrin, 2-hydroxy-propyl-β-cyclodextrin, 2-hydroxy-propyl-γ-cyclodextrin and mixtures thereof. In one aspect the one or more cyclodextrins is at least 2-hydroxy-propyl-α-cyclodextrin. In one aspect the one or more cyclodextrins is at least 2-hydroxy-propyl-O-cyclodextrin. In one aspect the one or more cyclodextrins is at least 2-hydroxy-propyl-γ-cyclodextrin.

We have found that 2-hydroxy-propyl derivatives of cyclodextrins, such as 2-hydroxy-propyl-β-cyclodextrin are particularly preferred since these derivatives have increased solubility in water when compared to base cyclodextrins such as O-cyclodextrin.

The one or more cyclodextrins may be present in any suitable amount in the aerosolizable formulation. In one aspect the one or more cyclodextrins are present in a total amount of no greater than 20 wt. % based on the aerosolizable formulation. In one aspect the one or more cyclodextrins are present in a total amount of no greater than 18 wt. % based on the aerosolizable formulation. In one aspect the one or more cyclodextrins are present in a total amount of no greater than 16 wt. % based on the aerosolizable formulation. In one aspect the one or more cyclodextrins are present in a total amount of no greater than 14 wt. % based on the aerosolizable formulation. In one aspect the one or more cyclodextrins are present in a total amount of no greater than 12 wt. % based on the aerosolizable formulation. In one aspect the one or more cyclodextrins are present in a total amount of no greater than 10 wt. % based on the aerosolizable formulation. In one aspect the one or more cyclodextrins are present in a total amount of no greater than 9 wt. % based on the aerosolizable formulation. In one aspect the one or more cyclodextrins are present in a total amount of no greater than 8 wt. % based on the aerosolizable formulation. In one aspect the one or more cyclodextrins are present in a total amount of no greater than 7 wt. % based on the aerosolizable formulation. In one aspect the one or more cyclodextrins are present in a total amount of no greater than 6 wt. % based on the aerosolizable formulation. In one aspect the one or more cyclodextrins are present in a total amount of no greater than 5 wt. % based on the aerosolizable formulation.

In one aspect the one or more cyclodextrins are present in a total amount of at least 1 wt. % based on the aerosolizable formulation. In one aspect the one or more cyclodextrins are present in a total amount of at least 2 wt. % based on the aerosolizable formulation. In one aspect the one or more cyclodextrins are present in a total amount of at least 3 wt. % based on the aerosolizable formulation. In one aspect the one or more cyclodextrins are present in a total amount of at least 4 wt. % based on the aerosolizable formulation. In one aspect the one or more cyclodextrins are present in a total amount of at least 5 wt. % based on the aerosolizable formulation. In one aspect the one or more cyclodextrins are present in a total amount of at least 6 wt. % based on the aerosolizable formulation. In one aspect the one or more cyclodextrins are present in a total amount of at least 7 wt. % based on the aerosolizable formulation. In one aspect the one or more cyclodextrins are present in a total amount of at least 8 wt. % based on the aerosolizable formulation.

In one aspect the one or more cyclodextrins are present in a total amount of from 1 to 20 wt. % based on the aerosolizable formulation. In one aspect the one or more cyclodextrins are present in a total amount of from 1 to 18 wt. % based on the aerosolizable formulation. In one aspect the one or more cyclodextrins are present in a total amount of from 1 to 16 wt. % based on the aerosolizable formulation. In one aspect the one or more cyclodextrins are present in a total amount of from 1 to 14 wt. % based on the aerosolizable formulation. In one aspect the one or more cyclodextrins are present in a total amount of from 1 to 12 wt. % based on the aerosolizable formulation. In one aspect the one or more cyclodextrins are present in a total amount of from 1 to 10 wt. % based on the aerosolizable formulation. In one aspect the one or more cyclodextrins are present in a total amount of from 1 to 9 wt. % based on the aerosolizable formulation. In one aspect the one or more cyclodextrins are present in a total amount of from 1 to 8 wt. % based on the aerosolizable formulation. In one aspect the one or more cyclodextrins are present in a total amount of from 1 to 7 wt. % based on the aerosolizable formulation. In one aspect the one or more cyclodextrins are present in a total amount of from 1 to 6 wt. % based on the aerosolizable formulation. In one aspect the one or more cyclodextrins are present in a total amount of from 1 to 5 wt. % based on the aerosolizable formulation.

In one aspect the one or more cyclodextrins are present in a total amount of from 2 to 20 wt. % based on the aerosolizable formulation. In one aspect the one or more cyclodextrins are present in a total amount of from 2 to 18 wt. % based on the aerosolizable formulation. In one aspect the one or more cyclodextrins are present in a total amount of from 2 to 16 wt. % based on the aerosolizable formulation. In one aspect the one or more cyclodextrins are present in a total amount of from 2 to 14 wt. % based on the aerosolizable formulation. In one aspect the one or more cyclodextrins are present in a total amount of from 2 to 12 wt. % based on the aerosolizable formulation. In one aspect the one or more cyclodextrins are present in a total amount of from 2 to 10 wt. % based on the aerosolizable formulation. In one aspect the one or more cyclodextrins are present in a total amount of from 2 to 9 wt. % based on the aerosolizable formulation. In one aspect the one or more cyclodextrins are present in a total amount of from 2 to 8 wt. % based on the aerosolizable formulation. In one aspect the one or more cyclodextrins are present in a total amount of from 2 to 7 wt. % based on the aerosolizable formulation. In one aspect the one or more cyclodextrins are present in a total amount of from 2 to 6 wt. % based on the aerosolizable formulation. In one aspect the one or more cyclodextrins are present in a total amount of from 2 to 5 wt. % based on the aerosolizable formulation.

As discussed herein, when one or more cyclodextrins, such as 2-hydroxy-propyl-β-cyclodextrin, are utilized the water content of the present formulation can be increased to high levels such as approximately 90%. When sufficient energy is imparted to the present formulation, the flavor (and any other active ingredients, if present) is readily freed from the host cyclodextrin and into the resulting aerosol. Ready availability of flavor (and active if present) also results in significant reduction of their respective inclusion levels to achieve enhanced delivery.

Aerosolizable Formulation

The aerosolizable formulation of the present invention may contain one or more further components. These components may be selected depending on the nature of the formulation. In one aspect, the aerosolizable formulation further comprises an active agent. By “active agent” it is meant an agent which has a biological effect on a subject when the aerosol is inhaled. The one or more active agents may be selected from nicotine, botanicals, and mixtures thereof. The one or more active agents may be of synthetic or natural origin. The active could be an extract from a botanical, such as from a plant in the tobacco family. An example active is nicotine. Thus, the present invention may provide an aerosolizable formulation comprising (i) water in an amount of at least 50 wt. % based on the aerosolizable formulation; (ii) one or more flavors; (iii) one or more cyclodextrins; and (iv) an active agent.

In one embodiment, the active agent is at least nicotine. In one embodiment the active agent is nicotine. Thus, the present invention may provide an aerosolizable formulation comprising

(i) water in an amount of at least 50 wt. % based on the aerosolizable formulation;

(ii) one or more flavors;

(iii) one or more cyclodextrins; and

(iv) nicotine.

Nicotine may be provided at any suitable amount depending on the desired dosage when inhaled by the user. In one aspect nicotine is present in an amount of no greater than 6 wt % based on the total weight of the aerosolizable formulation. In one aspect nicotine is present in an amount of from 0.4 to 6 wt % based on the total weight of the aerosolizable formulation. In one aspect nicotine is present in an amount of from 0.8 to 6 wt % based on the total weight of the aerosolizable formulation. In one aspect nicotine is present in an amount of from 1 to 6 wt % based on the total weight of the aerosolizable formulation. In one aspect nicotine is present in an amount of from 1.8 to 6 wt % based on the total weight of the aerosolizable formulation. In one aspect nicotine is present in an amount of from 0.4 to 5 wt % based on the total weight of the aerosolizable formulation. In one aspect nicotine is present in an amount of from 0.8 to 5 wt % based on the total weight of the aerosolizable formulation. In one aspect nicotine is present in an amount of from 1 to 5 wt % based on the total weight of the aerosolizable formulation. In one aspect nicotine is present in an amount of from 1.8 to 5 wt % based on the total weight of the aerosolizable formulation. In one aspect nicotine is present in an amount of no greater than 4 wt % based on the total weight of the aerosolizable formulation. In one aspect nicotine is present in an amount of from 0.4 to 4 wt % based on the total weight of the aerosolizable formulation. In one aspect nicotine is present in an amount of from 0.8 to 4 wt % based on the total weight of the aerosolizable formulation. In one aspect nicotine is present in an amount of from 1 to 4 wt % based on the total weight of the aerosolizable formulation. In one aspect nicotine is present in an amount of from 1.8 to 4 wt % based on the total weight of the aerosolizable formulation. In one aspect nicotine is present in an amount of no greater than 3 wt % based on the total weight of the aerosolizable formulation. In one aspect nicotine is present in an amount of from 0.4 to 3 wt % based on the total weight of the aerosolizable formulation. In one aspect nicotine is present in an amount of from 0.8 to 3 wt % based on the total weight of the aerosolizable formulation. In one aspect nicotine is present in an amount of from 1 to 3 wt % based on the total weight of the aerosolizable formulation. In one aspect nicotine is present in an amount of from 1.8 to 3 wt % based on the total weight of the aerosolizable formulation. In one aspect nicotine is present in an amount of no greater than 1.9 wt % based on the total weight of the aerosolizable formulation. In one aspect nicotine is present in an amount of no greater than 1.8 wt % based on the total weight of the aerosolizable formulation. In one aspect nicotine is present in an amount of from 0.4 to 1.9 wt % based on the total weight of the aerosolizable formulation. In one aspect nicotine is present in an amount of from 0.4 to 1.8 wt % based on the total weight of the aerosolizable formulation. In one aspect nicotine is present in an amount of from 0.5 to 1.9 wt % based on the total weight of the aerosolizable formulation. In one aspect nicotine is present in an amount of from 0.5 to 1.8 wt % based on the total weight of the aerosolizable formulation. In one aspect nicotine is present in an amount of from 0.8 to 1.9 wt % based on the total weight of the aerosolizable formulation. In one aspect nicotine is present in an amount of from 0.8 to 1.8 wt % based on the total weight of the aerosolizable formulation. In one aspect nicotine is present in an amount of from 1 to 1.9 wt % based on the total weight of the aerosolizable formulation. In one aspect nicotine is present in an amount of from 1 to 1.8 wt % based on the total weight of the aerosolizable formulation. In one aspect nicotine is present in an amount of less than 1.9 wt % based on the total weight of the aerosolizable formulation. In one aspect nicotine is present in an amount of less than 1.8 wt % based on the total weight of the aerosolizable formulation. In one aspect nicotine is present in an amount of from 0.4 to less than 1.9 wt % based on the total weight of the aerosolizable formulation. In one aspect nicotine is present in an amount of from 0.4 to less than 1.8 wt % based on the total weight of the aerosolizable formulation. In one aspect nicotine is present in an amount of from 0.5 to less than 1.9 wt % based on the total weight of the aerosolizable formulation. In one aspect nicotine is present in an amount of from 0.5 to less than 1.8 wt % based on the total weight of the aerosolizable formulation. In one aspect nicotine is present in an amount of from 0.8 to less than 1.9 wt % based on the total weight of the aerosolizable formulation. In one aspect nicotine is present in an amount of from 0.8 to less than 1.8 wt % based on the total weight of the aerosolizable formulation. In one aspect nicotine is present in an amount of from 1 to less than 1.9 wt % based on the total weight of the aerosolizable formulation. In one aspect nicotine is present in an amount of from 1 to less than 1.8 wt % based on the total weight of the aerosolizable formulation.

In one aspect nicotine is present in an amount of no greater than 6 wt % based on the total weight of the aerosolizable formulation. In one aspect nicotine is present in an amount of from 0.01 to 6 wt % based on the total weight of the aerosolizable formulation. In one aspect nicotine is present in an amount of from 0.02 to 6 wt % based on the total weight of the aerosolizable formulation. In one aspect nicotine is present in an amount of from 0.05 to 6 wt % based on the total weight of the aerosolizable formulation. In one aspect nicotine is present in an amount of from 0.08 to 6 wt % based on the total weight of the aerosolizable formulation. In one aspect nicotine is present in an amount of from 0.01 to 5 wt % based on the total weight of the aerosolizable formulation. In one aspect nicotine is present in an amount of from 0.02 to 5 wt % based on the total weight of the aerosolizable formulation. In one aspect nicotine is present in an amount of from 0.05 to 5 wt % based on the total weight of the aerosolizable formulation. In one aspect nicotine is present in an amount of from 0.08 to 5 wt % based on the total weight of the aerosolizable formulation. In one aspect nicotine is present in an amount of no greater than 4 wt % based on the total weight of the aerosolizable formulation. In one aspect nicotine is present in an amount of from 0.01 to 4 wt % based on the total weight of the aerosolizable formulation. In one aspect nicotine is present in an amount of from 0.02 to 4 wt % based on the total weight of the aerosolizable formulation. In one aspect nicotine is present in an amount of from 0.05 to 4 wt % based on the total weight of the aerosolizable formulation. In one aspect nicotine is present in an amount of from 0.08 to 4 wt % based on the total weight of the aerosolizable formulation. In one aspect nicotine is present in an amount of no greater than 3 wt % based on the total weight of the aerosolizable formulation. In one aspect nicotine is present in an amount of from 0.01 to 3 wt % based on the total weight of the aerosolizable formulation. In one aspect nicotine is present in an amount of from 0.02 to 3 wt % based on the total weight of the aerosolizable formulation. In one aspect nicotine is present in an amount of from 0.05 to 3 wt % based on the total weight of the aerosolizable formulation. In one aspect nicotine is present in an amount of from 0.08 to 3 wt % based on the total weight of the aerosolizable formulation. In one aspect nicotine is present in an amount of no greater than 2 wt % based on the total weight of the aerosolizable formulation. In one aspect nicotine is present in an amount of from 0.01 to 2 wt % based on the total weight of the aerosolizable formulation. In one aspect nicotine is present in an amount of from 0.02 to 2 wt % based on the total weight of the aerosolizable formulation. In one aspect nicotine is present in an amount of from 0.05 to 2 wt % based on the total weight of the aerosolizable formulation. In one aspect nicotine is present in an amount of from 0.08 to 2 wt % based on the total weight of the aerosolizable formulation. In one aspect nicotine is present in an amount of no greater than 1 wt % based on the total weight of the aerosolizable formulation. In one aspect nicotine is present in an amount of from 0.01 to 1 wt % based on the total weight of the aerosolizable formulation. In one aspect nicotine is present in an amount of from 0.02 to 1 wt % based on the total weight of the aerosolizable formulation. In one aspect nicotine is present in an amount of from 0.05 to 1 wt % based on the total weight of the aerosolizable formulation. In one aspect nicotine is present in an amount of from 0.08 to 1 wt % based on the total weight of the aerosolizable formulation. In one aspect nicotine is present in an amount of from 0.1 to 1 wt % based on the total weight of the aerosolizable formulation. In one aspect nicotine is present in an amount of no greater than 0.5 wt % based on the total weight of the aerosolizable formulation. In one aspect nicotine is present in an amount of from 0.01 to 0.5 wt % based on the total weight of the aerosolizable formulation. In one aspect nicotine is present in an amount of from 0.02 to 0.5 wt % based on the total weight of the aerosolizable formulation. In one aspect nicotine is present in an amount of from 0.05 to 0.5 wt % based on the total weight of the aerosolizable formulation. In one aspect nicotine is present in an amount of from 0.08 to 0.5 wt % based on the total weight of the aerosolizable formulation. In one aspect nicotine is present in an amount of no greater than 0.2 wt % based on the total weight of the aerosolizable formulation. In one aspect nicotine is present in an amount of from 0.01 to 0.2 wt % based on the total weight of the aerosolizable formulation. In one aspect nicotine is present in an amount of from 0.02 to 0.2 wt % based on the total weight of the aerosolizable formulation. In one aspect nicotine is present in an amount of from 0.05 to 0.2 wt % based on the total weight of the aerosolizable formulation. In one aspect nicotine is present in an amount of from 0.08 to 0.2 wt % based on the total weight of the aerosolizable formulation.

As discussed herein, we have found that each of the α, β and γ variants of cyclodextrin may be used and the most suitable one may be selected depending on the ‘guest’ components, such as the present flavors, to be complexed. We have found that the 13 variant complexes well with nicotine and other structurally similar active substances, so a small inclusion level is likely. 2-hydroxy-propyl-β-cyclodextrin complexes well with cyclic molecules which includes nicotine, but also key flavor components such as menthol and vanillin.

We have found that the addition of a combination of the one or more actives and the one or more flavors in a combined molar excess with respect to the one or more cyclodextrins may result in the actives and flavors precipitating from the formulation. Therefore in one aspect, the one or more cyclodextrins are present in a molar excess with respect to total combined amount of the one or more flavors and the one or more actives. In one aspect, the one or more cyclodextrins are present in a molar excess with respect to total combined amount of the one or more flavors and nicotine. In one aspect, the molar ratio of cyclodextrins to flavors and nicotine combined is at least 1.2:1. In one aspect, the molar ratio of cyclodextrins to flavors and nicotine combined is at least 1.4:1. In one aspect, the molar ratio of cyclodextrins to flavors and nicotine combined is at least 1.6:1. In one aspect, the molar ratio of cyclodextrins to flavors and nicotine combined is at least 1.8:1. In one aspect, the molar ratio of cyclodextrins to flavors and nicotine combined is at least 2:1. In one aspect, the molar ratio of cyclodextrins to flavors and nicotine combined is from 5:1 to 1.5:1. In one aspect, the molar ratio of cyclodextrins to flavors and nicotine combined is from 4:1 to 1.5:1. In one aspect, the molar ratio of cyclodextrins to flavors and nicotine combined is from 2:1 to 1.5:1. In one aspect, the molar ratio of cyclodextrins to flavors and nicotine combined is from 2:1 to 1.5:1. In one aspect, the molar ratio of cyclodextrins to flavors and nicotine combined is from 2:1 to 1.2:1.

Due to the high water inclusion, preservative materials may be present to inhibit microbial growth.

Process

As discussed herein, the present invention provides a process for forming an aerosol, the process comprising aerosolizing an aerosolizable formulation comprising

(i) water in an amount of at least 50 wt. % based on the aerosolizable formulation;

(ii) one or more flavors; and

(iii) one or more cyclodextrins.

In one aspect, the aerosol is formed without heating the aerosolizable formulation to a temperature above 100° C. In one aspect, the aerosol is formed without heating the aerosolizable formulation to a temperature above 90° C. In one aspect, the aerosol is formed without heating the aerosolizable formulation to a temperature above 80° C.

In one aspect, the aerosol is formed by a process performed at a temperature below 60° C. In one aspect, the aerosol is formed by a process performed at a temperature below 50° C. In one aspect, the aerosol is formed by a process performed at a temperature below 40° C.

In one aspect, the aerosol is formed by applying ultrasonic energy to the aerosolizable formulation. In particular, in one embodiment the formulation is passed through the interstices of a vibrating mesh in order to form an aerosol. Suitable devices which utilize vibrating mesh technology include the EFLOW® rapid nebulizer system available from Pari.

As discussed herein, the present invention further provides a process for preparing an aerosolizable formulation comprising

(i) water in an amount of at least 50 wt. % based on the aerosolizable formulation;

(ii) one or more flavors;

(iii) one or more cyclodextrins; and

(iv) one or more active agents,

the process comprising the steps of

(a) contacting water, the one or more cyclodextrins and at least one of the one or more active agents to form an initial cyclodextrin composition;

(b) subsequently contacting the initial cyclodextrin composition with the one or more flavors.

We have found that although complexation methods for flavors and cyclodextrins are known, the above process of complexation in situ is flavored. It is believed that this is due to the large difference in melting points between flavors, such as menthol (42-45° C.), and cyclodextrins, such as HPbCD (˜200° C.). This is particularly evident with kneading, since a sticky paste is formed and is very difficult to work with.

In the process of the present invention, preferably step (a) and/or step (b) is performed at a temperature of at least 30° C., such as at least 40° C. In one aspect the one or more cyclodextrins each have a melting point greater than each of the one or more flavors.

The active agents are added after formation of the initial cyclodextrin composition. This is due to the generally higher binding energy (vs. active agents such as nicotine) with the cyclodextrin host. With the larger disparity in binding energies, the less chance of a competing complexation mechanism with active agents. In one embodiment, the active agent is at least nicotine. In one embodiment the active agent is nicotine.

Further Aspects

The aerosolizable formulation may be contained or delivered by any means. In one aspect the present invention provides a contained aerosolizable formulation comprising

(a) a container; and

(b) an aerosolizable formulation, comprising

(i) water in an amount of at least 50 wt. % based on the aerosolizable formulation;

(ii) one or more flavors; and

(iii) one or more cyclodextrins.

The container may be any suitable container, for example to allow for the storage or delivery of the solution. In one aspect the container is configured for engagement with an electronic aerosol provision system. The container may be a bottle. The container may be configured to become fluidly in communication with an electronic aerosol provision system so that solution may be delivered to the electronic aerosol provision system. As described above, the present disclosure relates to container which may be used in an electronic aerosol provision system, such as an e-cigarette. Throughout the following description the term “e-cigarette” is used; however, this term may be used interchangeably with electronic aerosol provision system.

As discussed herein, the container of the present invention is typically provided for the delivery of aerosolizable formulation to or within an e-cigarette. The aerosolizable formulation may be held within an e-cigarette or may be sold as a separate container for subsequent use with or in an e-cigarette. As understood by one skilled in the art, e-cigarettes may contain a unit known as a detachable cartomiser which typically comprises a reservoir of aerosolizable formulation, a wick material and a device for aerosolizing the aerosolizable formulation. In some e-cigarettes, the cartomiser is part of a single-piece device and is not detachable. In one aspect the container is a cartomiser or is part of a cartomiser. In one aspect the container is not a cartomiser or part of a cartomiser and is a container, such as a tank, which may be used to deliver aerosolizable formulation to or within an e-cigarette.

In one aspect the container is part of an e-cigarette. Therefore in a further aspect the present invention provides an electronic aerosol provision system comprising:

(a) an aerosolizer for aerosolizing formulation for inhalation by a user of the electronic aerosol provision system;

(b) a power supply comprising a cell or battery for supplying power to the aerosolizer

(c) an aerosolizable formulation, comprising

(i) water in an amount of at least 50 wt. % based on the aerosolizable formulation;

(ii) one or more flavors; and

(iii) one or more cyclodextrins.

In addition to the aerosolizable formulation of the present invention and to systems such as containers and electronic aerosol provision systems containing the same, the present invention provides a process for at least one of increasing solubility of a flavor and/or reducing loss of flavor over time of a flavored aerosolizable formulation

the process comprising the steps of

(a) providing an aerosolizable material comprising water in an amount of at least 50 wt. % based on the aerosolizable material;

(b) incorporating into the aerosolizable material one or more flavors and one or more cyclodextrins.

The process of the present invention may comprises additional steps either before the steps listed, after the steps listed or between one or more of the steps listed.

In addition to the aerosolizable formulation of the present invention and to systems such as containers and electronic aerosol provision systems containing the same, the present invention provides use of one or more cyclodextrins for delivering a flavor in an aerosol, wherein the aerosol is formed by aerosolizing an aerosolizable formulation comprising

(i) water in an amount of at least 50 wt. % based on the aerosolizable formulation;

(ii) one or more flavors; and

(iii) one or more cyclodextrins.

at a temperature below 50° C.

### BRIEF DESCRIPTION OF THE DRAWINGS

Embodiments of the present invention will now be described in further detail by way of example only with reference to the accompanying figure in which:

FIGS. 1 to 8 each show a chromatograph.

The invention will now be described with reference to the following non-limiting example.

### EXAMPLES

Formulations

The following formulations were prepared.

Composition of Candidate Formulation 1—Menthol flavored

| Component | % w/w |
|---|---|
| Water | 90.0 |
| 2-hydroxy-propyl-β-cyclodextrin [HPbCD] | 8.9 |
| 1-menthol | 0.9 |
| nicotine | 0.1 |

Composition of Candidate Formulation 2—Cherry flavored

| Component | % w/w |
|---|---|
| Water | 97.1 |
| 2-hydroxy-propyl-β-cyclodextrin | 2.5 |
| Dark Cherry Flavor | 0.3 |
| nicotine | 0.1 |

While menthol: β-cyclodextrin complexation methods are known in the art, it was found that complexation in situ is flavored with 2-hydroxy-propyl-β-cyclodextrin. It is believed that this is due to the large difference in melting points between menthol (42-45° C.) and HPbCD (˜200° C.). This is particularly evident with kneading, since a sticky paste is formed and is very difficult to work with. Likewise, due to enhanced solubility of HPbCD, co-precipitation was also unsuccessful.

During preparation, the formulation was stirred and warmed to approximately 40° C. This allows appropriate mixing of the components throughout the process. At this temperature, HPbCD is thermally stable, and should be added first.

Nicotine was then added. The flavor components were added last; this is due to the generally higher binding energy (vs. nicotine) with the cyclodextrin host. With the larger disparity in binding energies, the less chance of a competing complexation mechanism with nicotine. For the menthol example, the approximate binding energies are −4.13 Kcal·mol-1 (nicotine) and −5.06 Kcal·mol-1 (menthol). It should be noted that, for this example, and depending on loadings, slight precipitation of menthol may be observed on cooling from 40° C. to ambient. Microfiltration is necessary in this case, to remove any excess menthol which has not formed a complex with cyclodextrin.

Analytical Testing

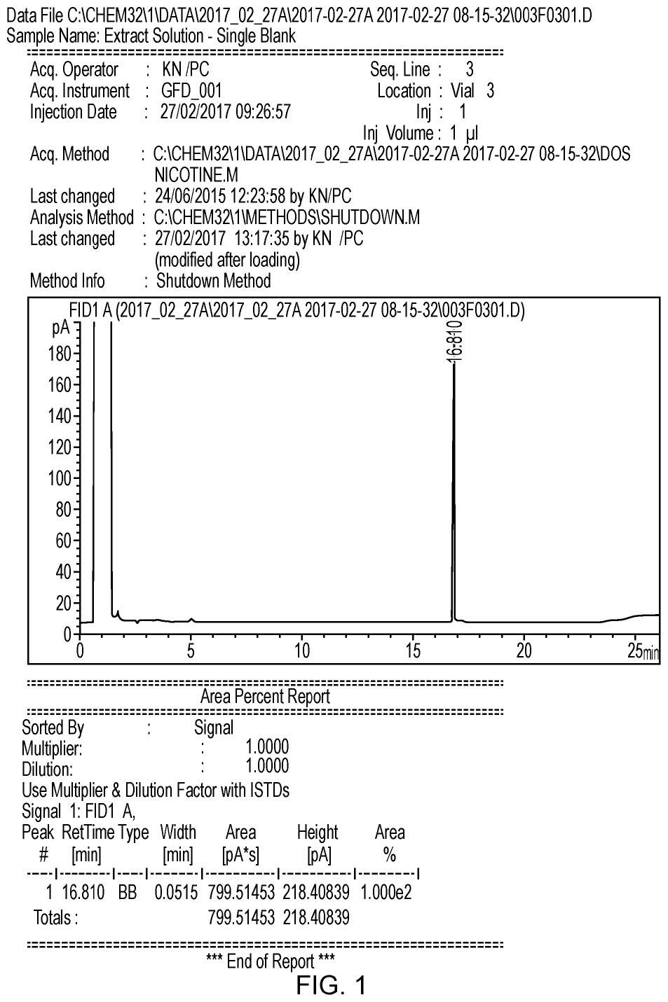

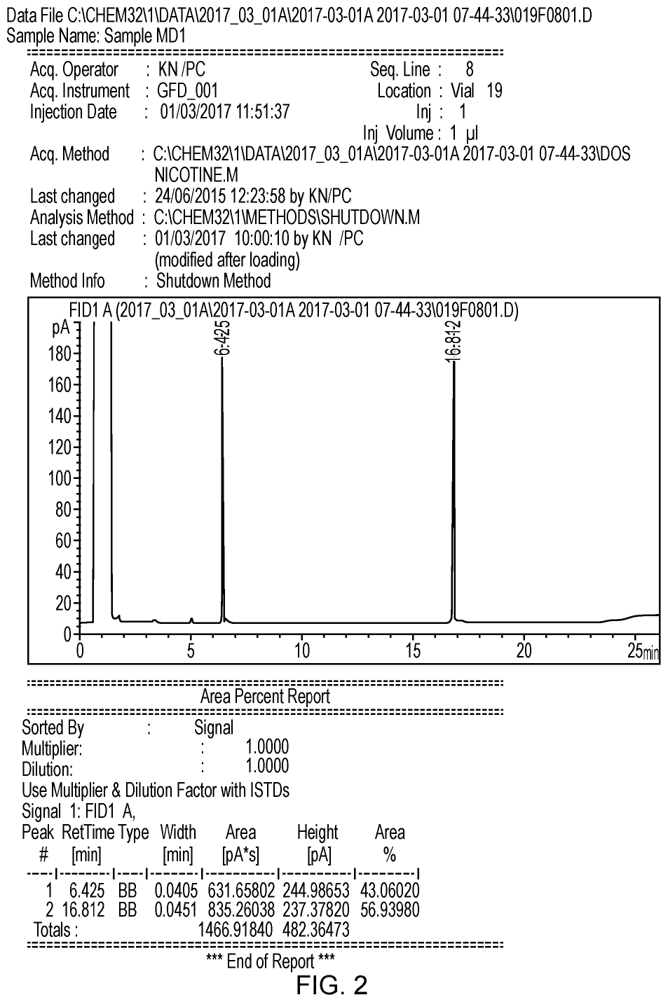

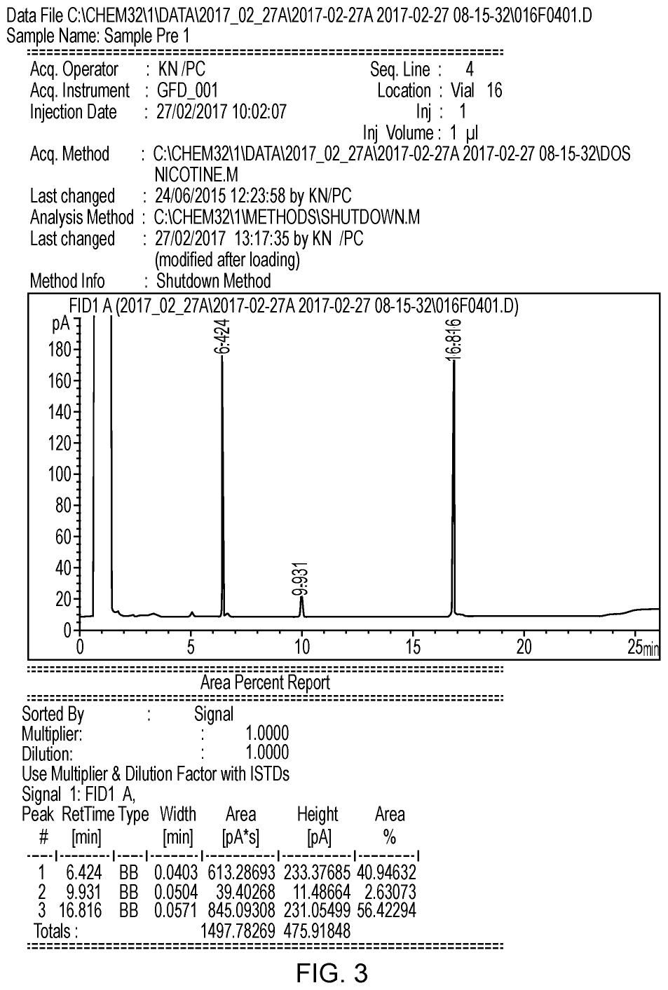

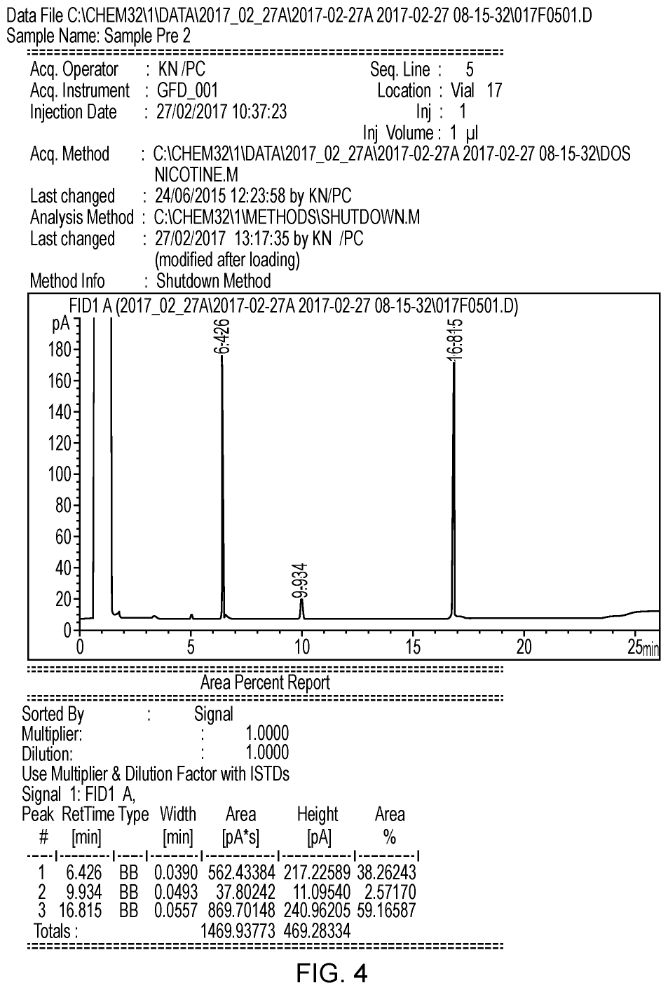

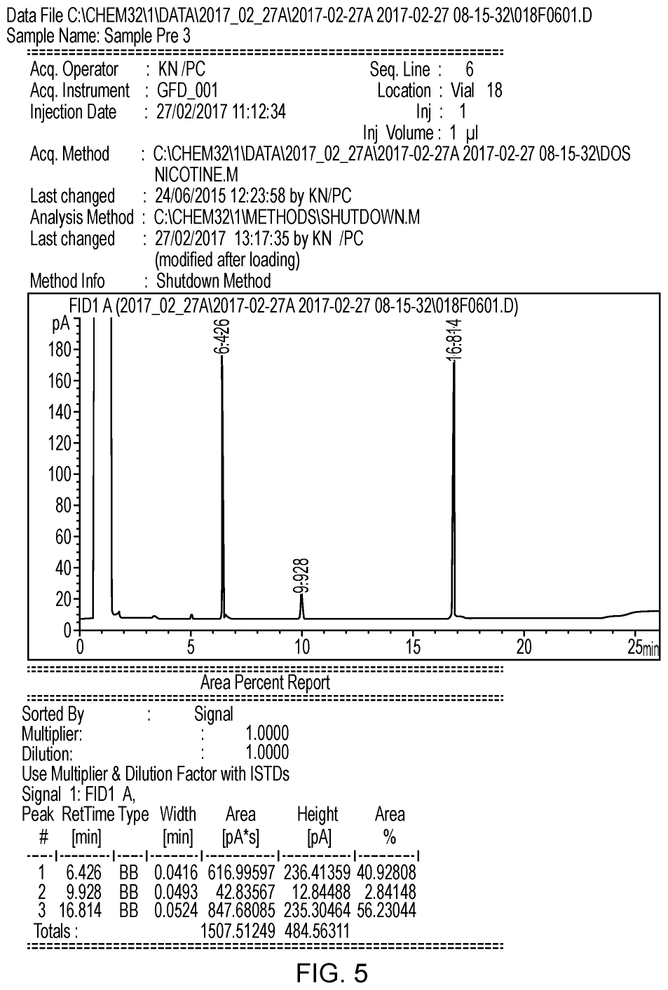

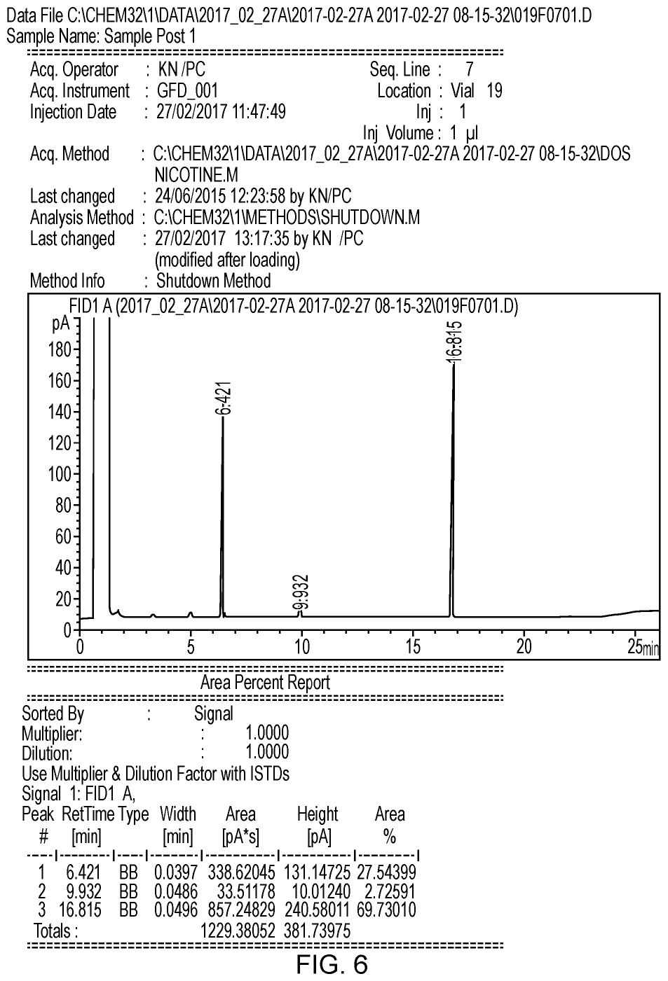

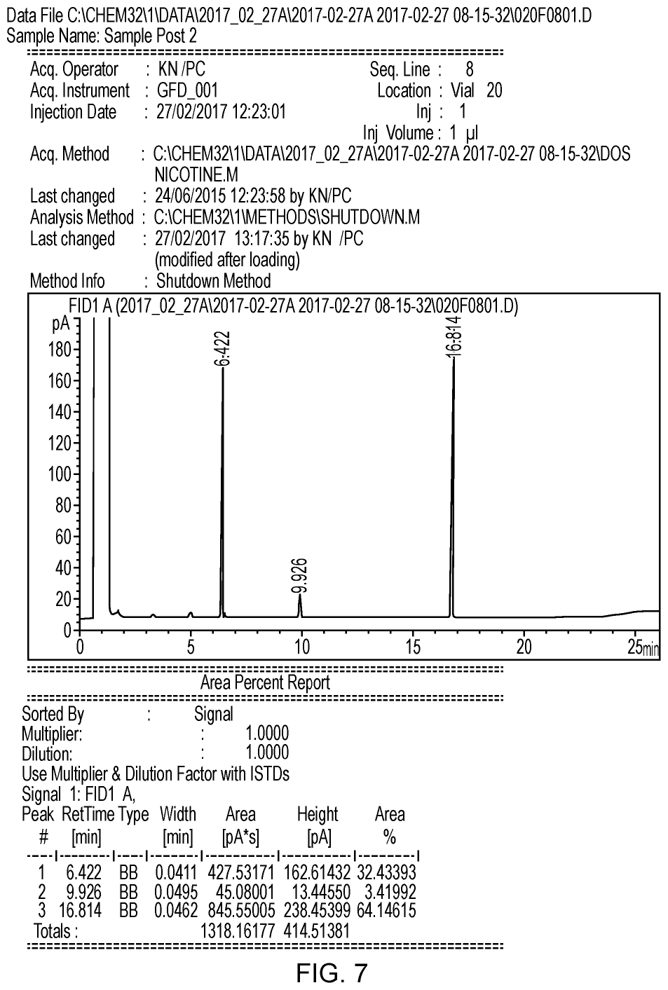

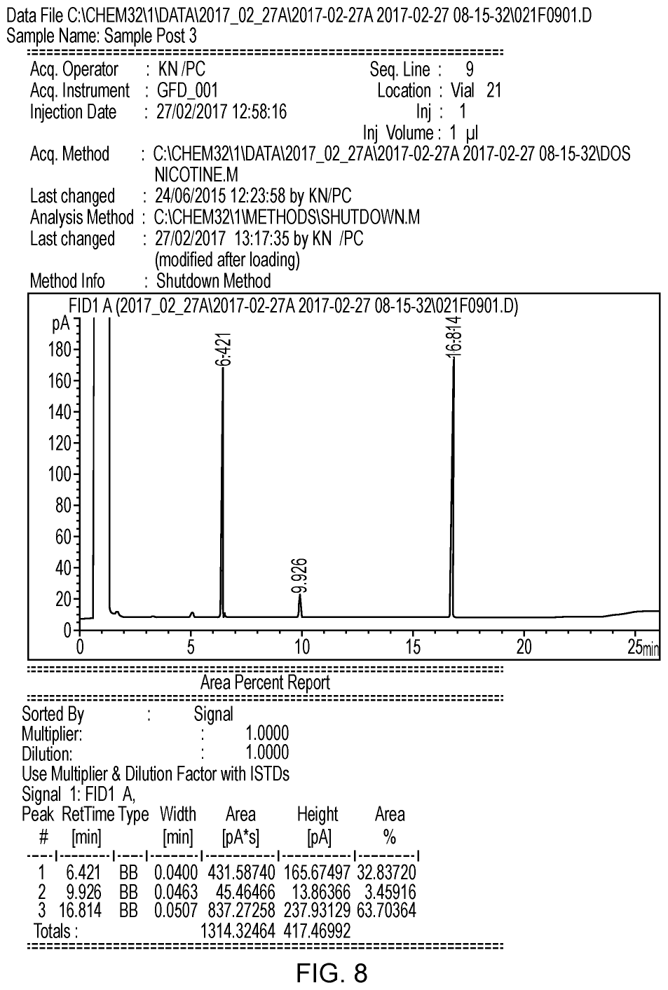

Prior to panel testing, the formulations were subjected to a vibrating mesh to form an aerosol. Analytical testing was then conducted on the formulation pre- and post-vibrating mesh. The chromatographs showed no evidence of component breakdown or degradation. Additionally, there were no traces of components not present in the base recipe, which may provide early insight to formulation stability. FIG. 1 shows a chromatograph for a blank and FIG. 2 shows a chromatograph for nicotine. FIGS. 3, 4 and 5 show analytical testing for 3 formulations pre-vibrating mesh. FIGS. 6, 7 and 8 show analytical testing for 3 formulations post-vibrating mesh.

There was not a significant difference in the peak heights of menthol or nicotine pre- and post-mesh. This suggests that the components are readily released from the complexed upon energy transfer from the vibrating mesh, then re-complex in the collection vessel post-capture. This is consistent with sensory findings where the flavor transfer is quick, implying quick initial release from the complex system.

Observational Testing

Observational testing was conducted using the described menthol candidate formulation, as a comparative example not in accordance with the present invention.

The findings are documented below. Flavor delivery was generally more favorable for the menthol variant vs the prior art (commercial) example.

8 sessions took place and 8 volunteers participated. Volunteers were asked to use three samples in total:

the above 2 water based formulations (above) formed into an aerosol using “EFLOW® Rapid device”. The EFLOW® Rapid is a reusable electronic inhalation system, used in the pharmaceutical industry for the treatment of diseases of the respiratory system and lungs. It is suitable for temporary oral inhalation of aqueous solutions typically prescribed or recommended by a doctor for use in the home. The device achieves its purpose through continuous aerosol delivery.

(EFLOW® rapid nebulizer system (www.pari.com)) and the above described comparative example.

Results

Compared to the prior art example, formulation 1 in accordance with the present invention was found to provide a) good, strong flavor, b) best menthol taste experienced, c) cool, refreshing, d) good menthol hit, e) pleasant taste in mouth after, f) goes well with cool vapor, g) nice sensory experience, h) clears nose, and i) refreshing taste at end.

The tested examples also had lower nicotine levels than is typically delivered in electronic cigarettes. The user panel were surprised when advised of this and it was considered that lower nicotine levels were more acceptable to users from a sensory perspective when delivered in the high water system of the present invention. This would allow users to reduce their nicotine intake without detriment to the sensory perception of the product.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. An aerosolizable formulation comprising:
(i) water in an amount of at least 70 wt. % based on the aerosolizable formulation;
(ii) one or more flavors;
(iii) one or more cyclodextrins; and
(iv) nicotine.

2. An aerosolizable formulation according to claim 1 wherein water is present in an amount of at least 75 wt. % based on the aerosolizable formulation.

3. An aerosolizable formulation according to claim 1 wherein water is present in an amount of at least 90 wt. % based on the aerosolizable formulation.

4. An aerosolizable formulation according to claim 1 wherein the one or more flavors flavours are selected from the group consisting of (4-(para-) methoxyphenyl)-2-butanone, vanillin, γ-undecalactone, menthone, 5-propenyl guaethol, menthol, para-mentha-8-thiol-3-one and mixtures thereof.

5. An aerosolizable formulation according to claim 1 wherein the flavor is at least menthol.

6. An aerosolizable formulation according to claim 1 wherein the one or more flavors are present in a total amount of no greater than 2 wt. % based on the aerosolizable formulation.

7. An aerosolizable formulation according to claim 1 wherein the one or more flavors are present in a total amount of from 0.01 to 1 wt. % based on the aerosolizable formulation.

8. An aerosolizable formulation according to claim 1 wherein the one or more cyclodextrins are selected from the group consisting of substituted or unsubstituted (α)-cyclodextrin, substituted or unsubstituted (β)-cyclodextrin, substituted or unsubstituted (γ)-cyclodextrin, and mixtures thereof.

9. An aerosolizable formulation according to claim 1 wherein the one or more cyclodextrins is at least 2-hydroxy-propyl-β-cyclodextrin.

10. An aerosolizable formulation according to claim 1 wherein the one or more cyclodextrins are present in a total amount of no greater than 10 wt. % based on the aerosolizable formulation.

11. An aerosolizable formulation according to claim 1 wherein the one or more cyclodextrins are present in a total amount of from 2 to 9 wt. % based on the aerosolizable formulation.

12. An aerosolizable formulation according to claim 1 wherein nicotine is present in an amount of no greater than 1.8 wt. % based on the aerosolizable formulation.

13. An aerosolizable formulation according to claim 12 wherein nicotine is present in an amount of from 0.1 to 1 wt. % based on the aerosolizable formulation.

14. A process for forming an aerosol, the process comprising aerosolising an aerosolizable formulation comprising:
(i) water in an amount of at least 70 wt. % based on the aerosolizable formulation;
(ii) one or more flavors;
(iii) one or more cyclodextrins; and
(iv) nicotine.

15. A process according to claim 14, wherein the aerosolizable formulation comprises water in an amount of at least 75 wt. %.

16. A process according to claim 14 wherein the aerosol is formed at a temperature below 50° C.

17. A process according to claim 14 wherein the aerosol is formed by applying ultrasonic energy to the aerosolizable formulation.

18. A contained aerosolizable formulation comprising:
(a) a container; and
(b) an aerosolizable formulation, comprising:
(i) water in an amount of at least 70 wt. % based on the aerosolizable formulation;
(ii) one or more flavours;
(iii) one or more cyclodextrins; and
(iv) nicotine.

19. A contained aerosolizable formulation according to claim 18 wherein the aerosolizable formulation is an aerosolizable formulation including water in an amount of at least 75 wt. %.

20. An electronic aerosol provision system comprising:
(a) an aerosolizer for aerosolizing a formulation for inhalation by a user of the electronic aerosol provision system;
(b) a power supply comprising a cell or battery for supplying power to the aerosolizer;
(c) the aerosolizable formulation, comprising:
(i) water in an amount of at least 70 wt. % based on the aerosolizable formulation;
(ii) one or more flavors; and
(iii) one or more cyclodextrins.

21. An electronic aerosol provision system according to claim 20 wherein the aerosolizable formulation further comprises an active agent.

22. An electronic aerosol provision system according to claim 21 wherein the active agent is at least nicotine.

23. An electronic aerosol provision system according to claim 20, the aerosolizable formulation including water in an amount of at least 75 wt. %.

24. A process for at least one of increasing solubility of a flavor and/or reducing loss of flavor over time of a flavoured aerosolizable formulation, the process comprising:
(a) providing an aerosolizable material comprising water in an amount of at least 70 wt. % based on the aerosolizable material; and
(b) incorporating into the aerosolizable material one or more flavors and one or more cyclodextrins.

25. A process for preparing an aerosolizable formulation comprising
(i) water in an amount of at least 70 wt. % based on the aerosolizable formulation;
(ii) one or more flavors;
(iii) one or more cyclodextrins; and
(iv) one or more active agents,
the process comprising:
(a) contacting water, the one or more cyclodextrins and at least one of the one or more active agents to form an initial cyclodextrin composition;
(b) subsequently contacting the initial cyclodextrin composition with the one or more flavors.

26. Use of one or more cyclodextrins for delivering a flavor in an aerosol, wherein the aerosol is formed by aerosolizing an aerosolizable formulation comprising:
(i) water in an amount of at least 70 wt. % based on the aerosolizable formulation;
(ii) one or more flavors; and
(iii) one or more cyclodextrins,
at a temperature below 50° C.
